(19) United States
(12) Patent Application Publication
(10) Pub. No.: US 2017/0103140 A1
(43) Pub. Date: Apr. 13, 2017

(54) DEVICE AND METHOD FOR OPTIMIZING WEB PAGE

(71) Applicant: HUAWEI TECHNOLOGIES CO., LTD., Shenzhen (CN)

(72) Inventors: ZhongHu ZHANG, Beijing (CN); Jianhua GUO, Beijing (CN)

(21) Appl. No.: 15/386,382

(22) Filed: Dec. 21, 2016

Related U.S. Application Data
(63) Continuation of application No. PCT/CN2014/080928, filed on Jun. 27, 2014.

(51) Int. Cl. G06F 17/30; G06F 17/27

(52) U.S. Cl. CPC G06F 17/30905; G06F 17/30896; G06F 17/30902; G06F 17/272

(57) ABSTRACT

Embodiments of the present invention provide a Web cache device, including: a transceiver, configured to acquire a HyperText Markup Language HTML file; and a processor, configured to parse the HTML file acquired by the transceiver, to determine information about a Java script JS file referenced in the HTML file or information about a cascading style sheet CSS file referenced in the HTML file, where the transceiver is further configured to acquire the JS file or the CSS file according to the information, determined by the processor, about the JS file or the information, determined by the processor, about the CSS file.

### CROSS-REFERENCE TO RELATED APPLICATIONS

This application is a continuation of International Application No. PCT/CN2014/080928, filed on Jun. 27, 2014, the disclosure of which is hereby incorporated by reference in its entirety.

### TECHNICAL FIELD

The present invention relates to the field of communications technologies, and in particular, to a device and a method for optimizing a web page.

### BACKGROUND

In current medium and large scale Web sites, in order to improve the maintainability of the Web sites for better management, development, and maintenance, a cascading style sheet (Cascading Style Sheets, CSS) and a Java script (JavaScript, JS) are generally stored in a manner of an independent CSS file and an independent JS file, and are referenced in a HyperText Markup Language (HyperText Markup Language, HTML) file. In order to alleviate network congestion, and reduce bandwidth and a latency in Web access of a user, an operator starts to use a Web optimization technology.

In the prior art, an operator mainly optimizes Web access by using a Web caching technology, where when receiving a request for user equipment, a Web cache device returns a cached original HTML file to the user equipment. However, the existing Web caching technology brings finite gains to the user equipment.

### SUMMARY

Embodiments of the present invention provide a device and a method for optimizing a web page, which can increase a speed of accessing a web page by user equipment.

A first aspect of the embodiments of the present invention provides a Web cache device, which may include:

a transceiver, configured to acquire a HyperText Markup Language HTML file; and

a processor, configured to parse the HTML file acquired by the transceiver, to determine information about a Java script JS file referenced in the HTML file or information about a cascading style sheet CSS file referenced in the HTML file, where

the transceiver is further configured to acquire the JS file or the CSS file according to the information, determined by the processor, about the JS file or the information, determined by the processor, about the CSS file; and

the processor is further configured to inline content of the JS file or the CSS file acquired by the transceiver into the HTML file, so as to obtain an optimized HTML file.

With reference to the first aspect, in a first possible implementation manner, the processor is specifically configured to:

insert the content of the JS file into the HTML file, so that the HTML file includes a tag pair <script language=“javascript”></script>, where the tag pair <script language=“javascript”></script> includes the content of the JS file; and

delete a reference to the JS file from the HTML file.

With reference to the first aspect, in a second possible implementation manner, the processor is specifically configured to:

insert the content of the CSS file into the HTML file, so that the HTML file includes a tag pair <style type=“text/css”></style>, where the tag pair <style type=“text/css”></style> includes the content of the CSS file; and

delete a reference to the CSS file from the HTML file.

With reference to any one of the first aspect to the second possible implementation manner of the first aspect, in a third possible implementation manner, the content of the JS file is used for indicating at least one of the following elements that corresponds to the HTML file: an event, a variable, a trigger, and a function.

With reference to any one of the first aspect to the third possible implementation manner of the first aspect, in a fourth possible implementation manner, the content of the CSS file is used for indicating a display style corresponding to the HTML file.

With reference to any one of the first aspect to the fourth possible implementation manner of the first aspect, in a fifth possible implementation manner, the JS file is referenced in the HTML file by using a uniform resource locator URL in a <script> tag.

With reference to any one of the first aspect to the fifth possible implementation manner of the first aspect, in a sixth possible implementation manner, the CSS file is referenced in the HTML file by using a URL in a <link> tag or by using an @import URL.

With reference to any one of the first aspect to the sixth possible implementation manner of the first aspect, in a seventh possible implementation manner, the device further includes a storage, configured to cache the optimized HTML file.

With reference to any one of the first aspect to the seventh possible implementation manner of the first aspect, in an eighth possible implementation manner, the transceiver is specifically configured to:

receive a request message of user equipment, where the request message is used for requesting the HTML file; and

send the optimized HTML file to the user equipment.

A second aspect of the embodiments of the present invention provides a method for optimizing a web page, which may include:

acquiring, by a Web cache device, a HyperText Markup Language HTML file;

parsing, by the Web cache device, the HTML file, to determine information about a Java script JS file referenced in the HTML file or information about a cascading style sheet CSS file referenced in the HTML file, and acquiring the JS file or the CSS file according to the information about the JS file or the information about the CSS file; and

inlining, by the Web cache device, content of the JS file or the CSS file into the HTML file, so as to obtain an optimized HTML file.

With reference to the second aspect, in a first possible implementation manner, the inlining, by the Web cache device, content of the JS file into the HTML file includes:

inserting, by the Web cache device, the content of the JS file into the HTML file, so that the HTML file includes a tag pair <script language=“javascript”></script>, where the tag pair <script language=“javascript”></script> includes the content of the JS file; and

deleting, by the Web cache device, a reference to the JS file from the HTML file.

With reference to the second aspect, in a second possible implementation manner, the inlining, by the Web cache device, content of the CSS file into the HTML file includes:

inserting, by the Web cache device, the content of the CSS file into the HTML file, so that the HTML file includes a tag pair <style type=“text/css”></style>, where the tag pair <style type=“text/css”></style> includes the content of the CSS file; and

deleting, by the Web cache device, a reference to the CSS file from the HTML file.

With reference to any one of the second aspect to the second possible implementation manner of the second aspect, in a third possible implementation manner, the content of the JS file is used for indicating at least one of the following elements that corresponds to the HTML file: an event, a variable, a trigger, and a function.

With reference to any one of the second aspect to the third possible implementation manner of the second aspect, in a fourth possible implementation manner, the content of the CSS file is used for indicating a display style corresponding to the HTML file.

With reference to any one of the second aspect to the fourth possible implementation manner of the second aspect, in a fifth possible implementation manner, the JS file is referenced in the HTML file by using a uniform resource locator URL in a <script> tag.

With reference to any one of the second aspect to the fifth possible implementation manner of the second aspect, in a sixth possible implementation manner, the CSS file is referenced in the HTML file by using a URL in a <link> tag or by using an @import URL.

With reference to any one of the second aspect to the sixth possible implementation manner of the second aspect, in a seventh possible implementation manner, the Web cache device caches the optimized HTML file.

With reference to any one of the second aspect to the seventh possible implementation manner of the second aspect, in an eighth possible implementation manner, the method further includes:

receiving, by the Web cache device, a request message of user equipment, where the request message is used for requesting the HTML file; and

sending, by the Web cache device, the optimized HTML file to the user equipment.

In the embodiments of the present invention, a Web cache device can acquire an optimized HTML file by parsing an acquired HTML file and inlining content of a JS file or a CSS file referenced in the HTML file into the HTML file, so that after acquiring the optimized HTML file, user equipment can directly execute content of the optimized HTML file and directly display a web page without acquiring the JS file and the CSS file from a network, which increases a speed of accessing the web page by the user equipment, and improves experience of Web access of the user equipment.

### BRIEF DESCRIPTION OF DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of a Web cache device according to the embodiments of the present invention;

FIG. 2A and FIG. 2B are a schematic diagram of interaction for optimizing Web access by using a Web caching technology in the prior art;

FIG. 3A and FIG. 3B are a schematic diagram of interaction of an embodiment of a Web cache device according to the embodiments of the present invention; and

FIG. 4 is a schematic flowchart of a method for optimizing a web page according to the embodiments of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

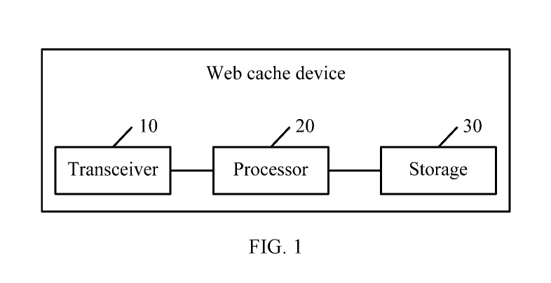

FIG. 1 is a schematic structural diagram of an embodiment of a Web cache device according to the embodiments of the present invention. The Web cache device described in this embodiment includes:

a transceiver 10, configured to acquire a HyperText Markup Language HTML file; and

a processor 20, configured to parse the HTML file acquired by the transceiver, to determine information about a Java script (JS) file referenced in the HTML file or information about a cascading style sheet CSS file referenced in the HTML file, where

the transceiver 10 is further configured to acquire the JS file or the CSS file according to the information, determined by the processor, about the JS file or the information, determined by the processor, about the CSS file; and

the processor 20 is further configured to inline content of the JS file or the CSS file acquired by the transceiver into the HTML file, so as to obtain an optimized HTML file.

In some feasible implementation manners, the processor 20 is specifically configured to:

insert the content of the JS file into the HTML file, so that the HTML file includes a tag pair <script language=“javascript”></script>, where the tag pair <script language=“javascript”></script> includes the content of the JS file; and

delete a reference to the JS file from the HTML file.

In some feasible implementation manners, the processor 20 is specifically configured to:

insert the content of the CSS file into the HTML file, so that the HTML file includes a tag pair <style type=“text/css”></style>, where the tag pair <style type=“text/css”></style> includes the content of the CSS file; and

delete a reference to the CSS file from the HTML file.

In some feasible implementation manners, the device further includes a storage 30, configured to cache the optimized HTML file.

In some feasible implementation manners, the transceiver 10 is specifically configured to:

receive a request message of user equipment, where the request message is used for requesting the HTML file; and

send the optimized HTML file to the user equipment.

In specific implementation, the Web cache device described in this embodiment of the present invention is also referred to as a Web proxy device or another network device having functions of a Web cache and a Web proxy, which is not limited in this embodiment of the present invention. The transceiver 10 in the Web cache device described in this embodiment of the present invention may specifically be a chip, an apparatus, or the like, such as a receiver or a generator, that may have functions of receiving and/or sending data, which is not limited in this embodiment of the present invention. Similarly, the processor 20 described in this embodiment of the present invention may specifically be a device, such as a processor or a processing chip, having a data processing function, which is not limited herein. The storage device 30 described in this embodiment of the present invention may specifically be a device, such as a memory, having a data storage function, which is not limited herein.

In some feasible implementation manners, user equipment may interact with a Web server (or briefly referred to as a server) by using the Web cache device described in this embodiment of the present invention. In specific implementation, an implementation manner in which the user equipment interacts with the server by using the Web cache device or the Web proxy device may include two cases: a non-transparent proxy and a transparent proxy. The non-transparent proxy refers to that the user equipment perceives existence of the Web cache device, and when accessing a web page, the user equipment directly sends an HTTP request to the Web cache device; after receiving the HTTP request, the Web cache device serves as a proxy and forwards the HTTP request to the Web server; and after receiving the HTTP request, the Web server sends an HTTP response to the Web cache device according to requested content of the web page, and after receiving the HTTP response, the Web cache device serves as a proxy and forwards the HTTP response to the user equipment. The transparent proxy refers to that the user equipment does not perceive existence of the Web cache device (or the Web proxy device), and when accessing a web page, the user equipment directly sends the HTTP request to the Web server; after the Web cache device that serves as a proxy intercepts the HTTP request, the Web cache device masquerades as the user equipment to forward the HTTP request to the Web server; and after receiving the HTTP request, the Web server directly sends an HTTP response to the user equipment according to requested content of the web page, and after the Web cache device that serves as a proxy intercepts the HTTP response, the Web cache device masquerades as the Web server to forward the HTTP response to the user equipment. For both the non-transparent proxy and the transparent proxy, the user equipment interacts with the Web server by using the cache device. An implementation process of the present invention is specifically described below based on the background of the proxy technology.

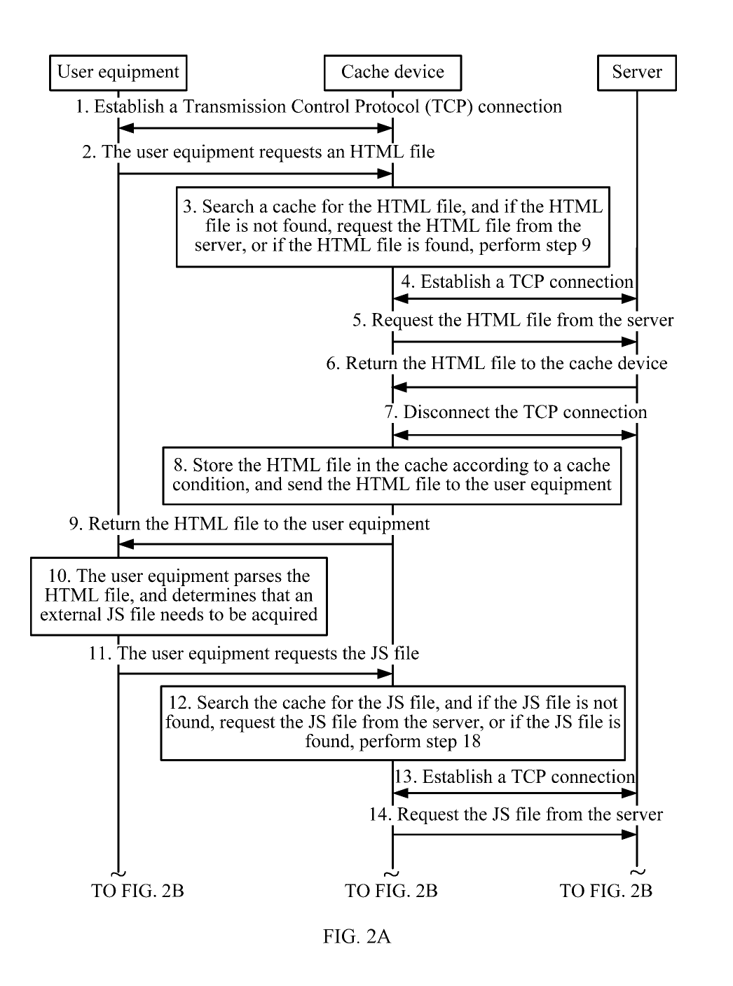

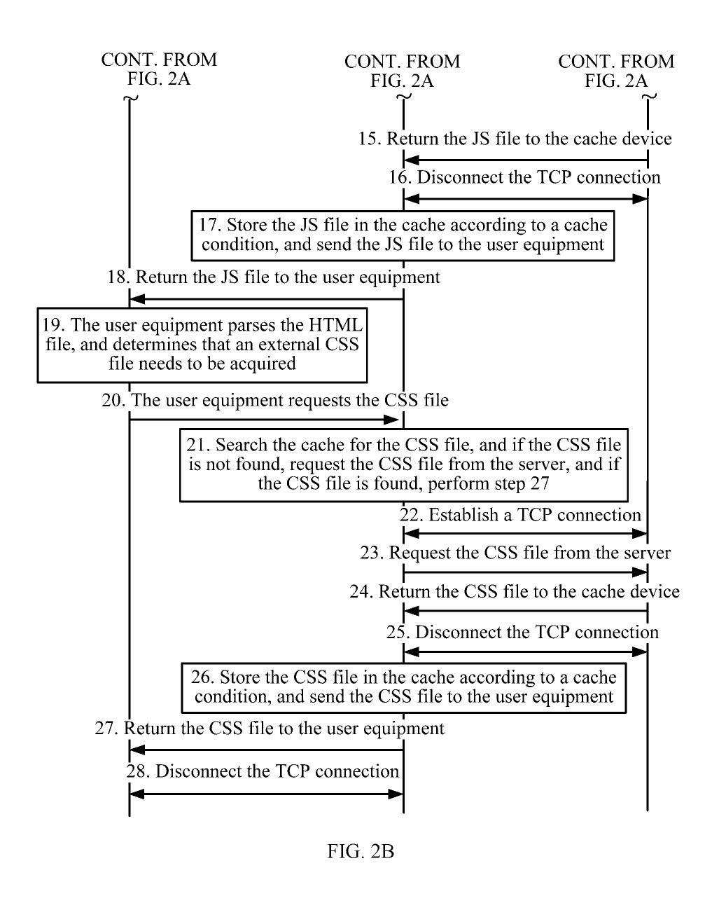

In the prior art, in order to alleviate network congestion, and reduce bandwidth and a latency in Web access of a user, an operator mainly optimizes Web access by using a Web caching technology, of which the basic principle is shown in FIG. 2A and FIG. 2B. Referring to FIG. 2A and FIG. 2B, an implementation process of optimizing Web access by using the Web caching technology in the prior art includes:

Step 1: User equipment establishes a Transmission Control Protocol (Transmission Control Protocol, TCP) connection to a cache device. That is, user equipment may first establish a TCP connection to a cache device, so as to request data from a server by using the cache device.

Step 2: The user equipment requests an HTML file from the cache device. After receiving the request of the user equipment, the cache device acquires the HTML file from a cache or requests the HTML file from the server.

Step 3: The cache device searches a cache for the HTML file, and if the cache device does not find the HTML file, the cache device requests the HTML file from the server, or if the cache device finds the HTML file, step 9 is performed.

Step 4: The cache device establishes a TCP connection to the server. After establishing a TCP connection to the server, the cache device may request the HTML file from the server.

Step 5: The cache device requests the HTML file from the server. After receiving the request of the cache device, the server may return the HTML file to the cache device, so that the HTML file is returned to the user equipment by using the cache device.

Step 6: The server returns the HTML file to the cache device.

Step 7: Disconnect the TCP connection.

Step 8: The cache device stores the HTML file in the cache according to a cache condition. That is, after receiving the HTML file returned by the server, the cache device may store, in the cache according to a cache condition, the HTML file returned by the server, and return the HTML file to the user equipment. After the HTML file is stored in the cache, when the user equipment requests the HTML file next time, the cache device can directly find the HTML file in the cache, and return the HTML file to the user equipment.

Step 9: The cache device returns the HTML file to the user equipment.

Step 10: The user equipment parses the HTML file, and determines that an external JS file needs to be acquired. That is, the user equipment may parse the HTML file returned by the cache device, if it is obtained by parsing that an external JS file is referenced in the HTML file, the user equipment needs to request the external JS file from the cache device or the server, and only after acquiring the JS file referenced in the HTML file, the user equipment can execute the HTML file to display content of a web page.

Step 11: The user equipment requests the JS file from the cache device.

Step 12: The cache device searches the cache for the JS file, and if the cache device does not find the JS file, the cache device requests the JS file from the server, or if the cache device finds the JS file, step 18 is performed, that is, the JS file is returned to the user equipment.

Step 13: The cache device establishes a TCP connection to the server. That is, when requesting the JS file from the server, the cache device may first establish a TCP connection to the server, and then send a request to the server.

Step 14: The cache device requests the JS file from the server.

Step 15: The server returns the JS file to the cache device. That is, after receiving the request for acquiring the JS file by the cache device, the server may return the JS file to the cache device, and after acquiring the JS file, the cache device may send the JS file to the user equipment.

Step 16: The cache device disconnects the TCP connection to the server. After returning the JS file to the cache device, the server may disconnect the TCP connection.

Step 17: The cache device stores the JS file in the cache according to the cache condition. That is, after receiving the JS file returned by the server, the cache device may store the acquired JS file in the cache according to a cache condition, and send the JS file to the user equipment. After the JS file is stored in the cache, if the user equipment requests acquiring the JS file next time, the cache device can search the cache for the JS file and return the JS file to the user equipment without requesting the JS file from the server.

Step 18: The cache device returns the JS file to the user equipment.

Step 19: The user equipment parses the HTML file, and determines that a CSS file needs to be acquired. That is, the user equipment may parse the HTML file returned by the cache device, if it is obtained by parsing that an external CSS file is referenced in the HTML file, the user equipment needs to request the external CSS file from the cache device or the server, and only after acquiring the CSS file referenced in the HTML file, the user equipment can execute the HTML file to display the content of the web page.

Step 20: The user equipment requests the CSS file from the cache device.

Step 21: The cache device searches the cache for the CSS file, and if the cache device does not find the CSS file, the cache device requests the CSS file from the server, or if the cache device finds the CSS file, step 27 is performed, that is, the CSS file is returned to the user equipment.

Step 22: The cache device establishes a TCP connection to the server. That is, when requesting the CSS file from the server, the cache device may first establish a TCP connection to the server, and then send a request to the server.

Step 23: The cache device requests the CSS file from the server.

Step 24: The server returns the CSS file to the cache device. That is, after receiving the request for acquiring the CSS file by the cache device, the server may return the CSS file to the cache device, and after acquiring the CSS file, the cache device may send the CSS file to the user equipment.

Step 25: The cache device disconnects the TCP connection to the server. After returning the CSS file to the cache device, the server may disconnect the TCP connection.

Step 26: The cache device stores the CSS file in the cache according to a cache condition, and sends the CSS file to the user equipment. That is, after receiving the CSS file returned by the server, the cache device may store the acquired CSS file in the cache according to a cache condition, and send the CSS file to the user equipment. After the CSS file is stored in the cache, if the user equipment requests acquiring the CSS file next time, the cache device can search the cache for the CSS file and return the CSS file to the user equipment without requesting the CSS file from the server.

Step 27: The cache device returns the CSS file to the user equipment.

Step 28: Disconnect the TCP connection.

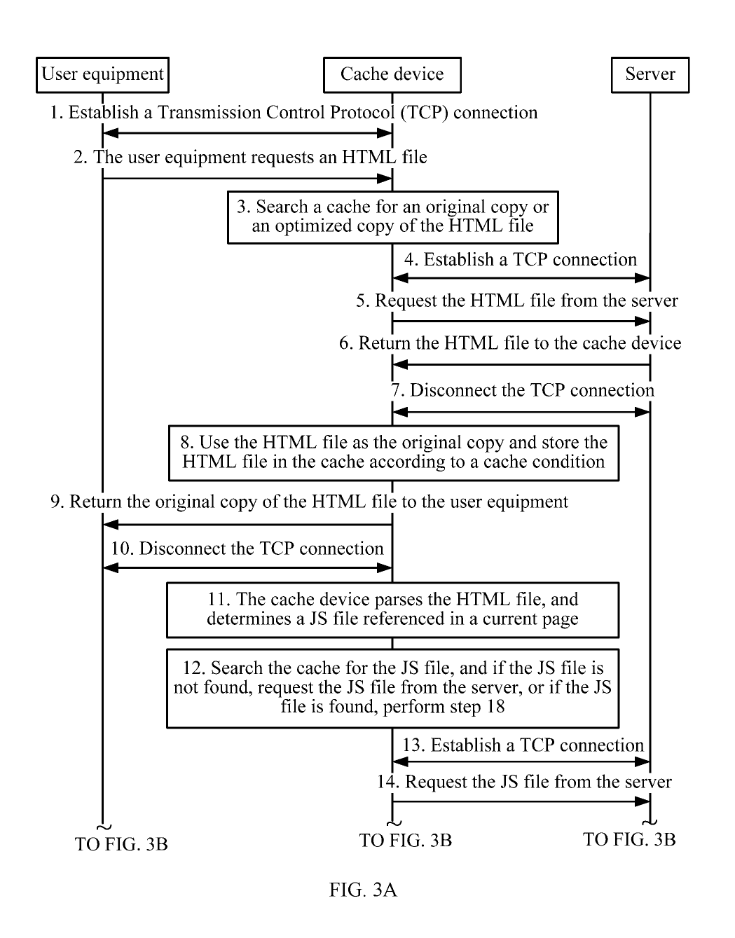

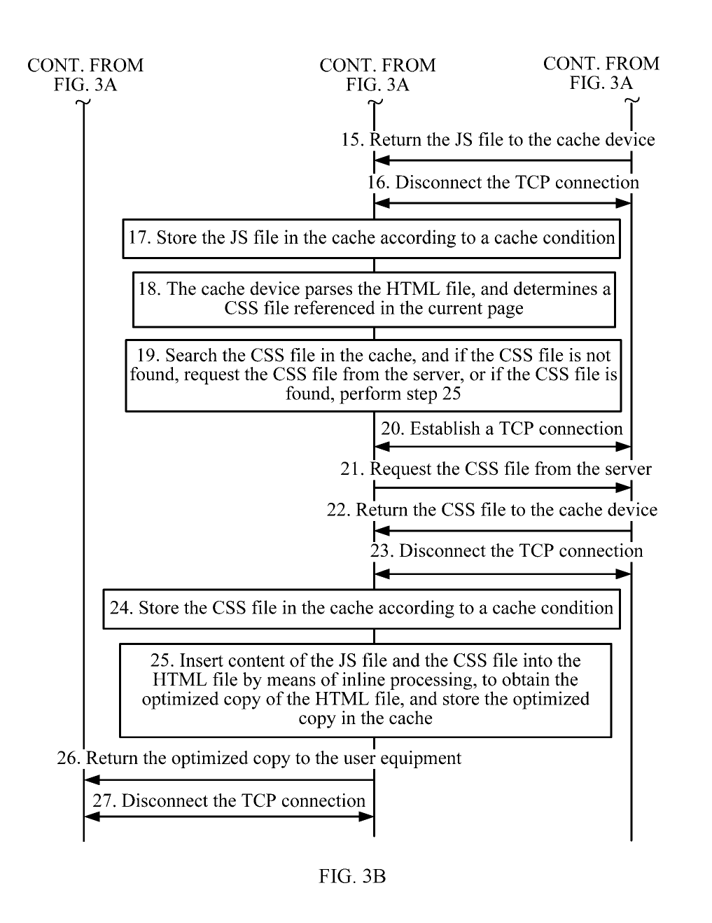

It can be known from the foregoing content that, in the existing Web caching technology, content of an original web page is returned by a Web cache device to user equipment, and if an external CSS file and/or JS file is referenced in the original web page, the user equipment initiates another request to the Web cache device or a Web server, to request the external CSS file and/or JS file referenced in the original web page. It can be seen that, only network traffic between the Web cache device and the Web server can be reduced by using the existing Web caching technology, network traffic between a client and the Web cache device cannot be reduced, and a latency of Web access cannot be reduced, either. In this embodiment of the present invention, the Web cache device may parse an acquired HTML file, determine a JS file or CSS file referenced in the HTML file, inline content of the acquired JS file or CSS file into the HTML file, to obtain an optimized HTML file, and then send the optimized HTML file to user equipment. The user equipment can directly execute the optimized HTML file without requesting the JS file or the CSS file. A specific implementation process of an embodiment of a Web cache device provided in the embodiments of the present invention is described below in detail with reference to FIG. 3A and FIG. 3B.

Referring to FIG. 3A and FIG. 3B, a process in which a Web cache device provided in an embodiment of the present invention optimizes a web page may include:

Step 1: User equipment establishes a TCP connection to a cache device. When the user equipment accesses a web page, a Web cache device (that is, the cache device described in FIG. 3A and FIG. 3B) serves as a proxy, and may first establish a TCP connection to the user equipment. After establishing the TCP connection to the cache device, the user equipment may initiate a HyperText Transfer Protocol (HyperText Transfer Protocol, HTTP) request for acquiring an HTML file to the Web cache device, for example, the user equipment may request an HTML file of a web page “sport.sina.com/football.html” from the Web cache device.

After receiving the request that is for acquiring the HTML file and is initiated by the user equipment, the Web cache device may search a Web cache for an original copy or an optimized copy of the HTML file of the web page “sport.sina.com/football.html” according to a user policy. For example, when the user policy indicates that the original copy is to be returned, the cache device may search the Web cache for the original copy of the page “sport.sina.com/football.html”, and if the cache device finds the original copy, the cache device returns the original copy to the user equipment; otherwise, the cache device requests the original copy of the page “sport.sina.com/football.html” from a Web server, and returns the original copy to the user equipment. When the user policy indicates that the optimized copy is to be returned, the cache device may search the Web cache for the optimized copy of the page “sport.sina.com/football.html”, and if the cache device finds the optimized copy, the cache device returns the optimized copy to the user equipment; otherwise, the cache device generates the optimized copy of the page “sport.sina.com/football.html”, and returns the optimized copy to the user equipment. In specific implementation, a specific implementation manner of returning the original copy of the web page to the user equipment is an existing implementation manner (for details, reference may be made to the implementation manner corresponding to FIG. 2A and FIG. 2B in the prior art), and is not specifically described again in this embodiment of the present invention. A specific implementation manner of returning the optimized copy (that is, an optimized HTML file) of the web page to the user equipment is described below.

Step 2: The user equipment requests an HTML file from the cache device.

Step 3: The cache device searches a cache for an original copy or an optimized copy of the HTML file.

In some feasible implementation manners, after the transceiver 10 of the Web cache device receives the request that is for acquiring the HTML file and is initiated by the user equipment, the processor 20 may search the Web cache for the HTML file, and if the processor finds the HTML file in the Web cache, the transceiver 10 may directly acquire the HTML file from the Web cache; otherwise, the processor 20 may request the HTML file from the Web server, and acquire the HTML file from the Web server, and the storage 30 stores the acquired HTML file in the Web cache according to a cache condition.

Step 4: The cache device establishes a TCP connection to a server.

Step 5: The cache device requests the HTML file from the server.

Step 6: The server returns the HTML file to the cache device.

Step 7: The cache device disconnects the TCP connection to the server.

Specifically, when requesting the HTML file from the server, the Web cache device may first establish a TCP connection to the Web server, and after the TCP connection is established, the Web cache device may request the HTML file of the Web page “sport.sina.com/football.html” from the Web server by using the processor 20. After receiving the request of the Web cache device, the Web server may return the HTML file of the web page “sport.sina.com/football.html” to the Web cache device, and after the HTML file is successfully returned, the Web cache device disconnects the TCP connection.

Step 8: The cache device uses the HTML file as the original copy and stores the original copy in the cache according to a cache condition.

In some feasible implementation manners, after the transceiver 10 of the Web cache device acquires the HTML file returned by the Web server, the storage 30 may store the HTML file in the Web cache according to the cache condition. Specifically, after the transceiver 10 of the Web cache device acquires the HTML file of the web page “sport.sina.com/football.html” from the server, the storage 30 may use the acquired HTML file as the original copy of the web page and store the HTML file in the Web cache, and the processor 20 then may inline content of a JS file and/or CSS file referenced in the web page into the original copy (description is made below by using an example in which the content of the JS file and the CSS file is inlined into the original copy), to generate the optimized copy (that is, the optimized HTML file) of the HTML file.

Step 9: The cache device returns the original copy of the HTML file to the user equipment.

Step 10: The cache device disconnects the TCP connection to the user equipment.

Step 11: The cache device parses the HTML file, and determines a JS file referenced in a current page.

Step 12: The cache device searches the cache for the JS file, and if the cache device does not find the JS file, the cache device requests the JS file from the server, or if the cache device finds the JS file, step 18 is performed.

Step 13: The cache device establishes a TCP connection to the server.

Step 14: The cache device requests the JS file from the server.

Step 15: The server returns the JS file to the cache device.

Step 16: The cache device disconnects the TCP connection to the server.

Step 17: The cache device stores the JS file in the cache according to a cache condition.

Step 18: The cache device parses the HTML file, and determines a CSS file referenced in the current page.

Step 19: The cache device searches the cache for the CSS file, and if the cache device does not find the CSS file, the cache device requests the CSS file from the server, or if the cache device finds the CSS file, step 25 is performed.

Step 20: The cache device establishes a TCP connection to the server.

Step 21: The cache device requests the CSS file from the server.

Step 22: The server returns the CSS file to the cache device.

Step 23: The cache device disconnects the TCP connection to the server.

Step 24: The cache device stores the CSS file in the cache according to a cache condition.

In some feasible implementation manners, after the transceiver 10 of the Web cache device acquires the HTML file of the web page “sport.sina.com/football.html” from the Web cache or the Web server, the processor 20 may parse the HTML file, and determine a JS file and a CSS file that are referenced in the web page (that is, the page “sport.sina.com/football.html” corresponding to the HTML file) to which access is requested by the user equipment. After determining the JS file and the CSS file that are referenced in the page, the processor 20 may search the Web cache for the JS file and the CSS file. Specifically, after parsing the HTML file of the web page “sport.sina.com/football.html”, and determining that the JS file referenced in the page is “sport.sina.com/football.js”, the processor 20 may search the Web cache for “sport.sina.com/football.js”. If the processor 20 finds the JS file in the Web cache, the transceiver 10 may acquire the JS file from the Web cache, and if the Web cache device does not find the JS file in the Web cache, the Web cache device may request the JS file from the Web server. Specifically, when requesting the JS file from the Web server by using the processor 20, the Web cache device may first establish a TCP connection to the Web server, and the processor 20 may send the request for acquiring the JS file to the Web server after the TCP connection is established. After receiving the request of the Web cache device, the Web server may return the JS file to the Web cache device, and then the TCP connection may be disconnected. After the JS file returned by the Web server is received, the processor 20 of the Web cache device may store the JS file in the Web cache according to a cache condition. Similarly, after the processor 20 parses the HTML file of the web page “sport.sina.com/football.html”, and determines that the CSS file referenced in the web page is “sport.sina.com/football.css”, the Web cache device may search the Web cache for “sport.sina.com/football.css”. If the processor 20 finds the CSS file in the Web cache, the transceiver 10 may acquire the CSS file from the Web cache, and if the processor 20 does not find the CSS file in the Web cache, the processor 20 may request the CSS file from the Web server. Specifically, when requesting the CSS file from the Web server by using the processor 20, the Web cache device may first establish a TCP connection to the Web server, and may send a request for acquiring the CSS file to the Web server after the TCP connection is established. After receiving the request of the Web cache device, the Web server may return the CSS file to the Web cache device, and then the TCP connection may be disconnected. After the transceiver 10 of the Web cache device receives the CSS file returned by the Web server, the storage 30 may store the CSS file in the Web cache according to a cache condition. After the transceiver 10 of the Web cache device acquires the JS file and the CSS file, the processor 20 may inline the content of the JS file and the content of the CSS file into the original copy of the HTML file, so as to generate the optimized copy.

Step 25: The cache device inserts content of the JS file and the CSS file into the HTML file by means of inlining, to obtain the optimized copy of the HTML file, and stores the optimized copy in the cache.

In some feasible implementation manners, after the transceiver 10 of the Web cache device acquires the JS file and the CSS file, the processor 20 may inline the content of the JS file and the content of the CSS file into the original copy of the HTML file, to generate the optimized copy of the HTML file. In this embodiment of the present invention, the optimized copy of the HTML file is directly executed by the user equipment to display the web page. In this embodiment of the present invention, the content of the JS file is used for indicating an element, such as an event, a variable, a trigger, or a function, corresponding to the HTML file, that is, the content of the JS file is used for defining an element, such as an event, a variable, a trigger, or a function, required when the HTML file of the page is interpreted and executed by a browser of the user equipment. The content of the CSS file is used for indicating a display style corresponding to the HTML file, that is, the content of the CSS file is used for defining a display style of the HTML file of the page. In an existing implementation manner, when an original copy of an HTML file references an external JS file, a uniform resource locator (Uniform Resource Locator, URL) of the JS file may be first specified in a <script> tag of the original copy, and the external JS file is referenced by using the specified URL of the JS file, that is, the JS file is referenced in the HTML file by using the URL in the <script> tag. Specifically, the <script> tag may be placed between a tag pair <head></head> of the HTML file (that is, the original copy), which is shown in the following Example 1:

### Example 1

```
<head>
    <script language=“javascript”
Src=“http://sports.sina.com/football.js”>
    </script>
    <link rel=“stylesheet” type=“text/css” href=
“http:/sprots.sina.com/football.css”/>
</head>
<body>
    <p>welcome</p>
</body>
```

In addition, the <script> tag may also be placed between a tag pair <body></body> of the HTML file, which is shown in the following Example 2:

### Example 2

```
<head>
    <style type=“text/css”>
    @import url(http:/sprots.sina.com/football.css);
    </style>
</head>
<body>
  <script language=“javascript”
src=“http://sports.sina.com/football.js”>
    </script>
  <p>welcome</p>
</body>
```

In specific implementation, when the original copy of the HTML file references an external CSS file, a URL of the CSS file may be first specified in a <link> tag of the original copy, and the external CSS file is referenced by using the URL of the CSS file, as shown in the foregoing Example 1. In addition, when the original copy of the HTML file references the external CSS file, the URL of the CSS file may also be specified in an @import tag of the original copy, and the external CSS file is referenced by using the @import URL, as shown in the foregoing Example 2. After the user equipment receives the original copy, which includes the content described in the foregoing Example 1 or Example 2, of the HTML file, if the user equipment does not cache the CSS file (sport.sina.com/football.css) and the JS file (sport.sina.com/football.js), the user equipment further initiates other two web requests, to separately request the content of the JS file (sport.sina.com/football.js) and the content of the CSS file (sport.sina.com/football.css), so as to acquire the JS file and the CSS file, which increases communication traffic between the user equipment, the Web cache device, and the server as well as a latency of Web access. In this embodiment of the present invention, content of the JS file and the CSS file may be inlined into the original copy of the HTML file, so as to reduce the number of requests initiated by the user equipment, reduce communication traffic between the user equipment, the Web cache device, and the server, and increase a speed of accessing the web page.

In specific implementation, the processor 20 of the Web cache device may insert the content of the JS file into the HTML file, so that the HTML file includes a tag pair <script language=“javascript”></script>, where the tag pair <script language=“javascript”></script> includes the content of the JS file. The processor 20 may insert the content of the CSS file into the HTML file, so that the HTML file includes a tag pair <style type=“text/css”></style>, where the tag pair <style type=“text/css”></style> includes the content of the CSS file. Specifically, the processor 20 may first place the content of the acquired JS file between the tag pair <script language=“javascript”></script> shown in Example 1, and place the content of the CSS file between the tag pair <style type=“text/css”></style>. When inlining the content of the JS file into the original copy of the HTML file, the processor 20 may replace a tag pair <script></script>, which references the external JS file by using the URL, in the original copy of the HTML with the tag pair <script language=“javascript”></script> including the content of the JS file, that is, the Web cache device may delete a reference to the JS file from the HTML file, and directly insert the content of the JS file into the HTML file. When inlining the content of the CSS file into the original copy of the HTML file, the processor 20 may replace a tag pair <style></style>, which references the external JS file by using the URL in the <link> tag, in the original copy of the HTML with the tag pair <style type=“text/css”></style> including the content of the CSS file, that is, the processor 20 may delete a reference to the CSS file from the HTML file, and directly insert the content of the CSS file into the HTML file. When inlining the content of the CSS file into the original copy of the HTML file, the processor 20 of the Web cache device may also replace a tag pair <style></style>, which references the external CSS file by using an @import URL, in the original copy of the HTML with the tag pair <style type=“text/css”></style> including the content of the CSS file. In specific implementation, the processor 20 of the Web cache device may acquire the JS file and the CSS file from the Web cache or the Web server. For example, the content of the JS file is:

“alert(‘welcome’)”;

for example, the content of the CSS file is:

“hr {color: sienna;}

p {margin-left: 20px;}

body {background-image: url(“images/back40.gif”}”

After acquiring the content of the JS file and the CSS file, the processor 20 of the Web cache device may inline the content of the JS file and the CSS file into the original copy of the HTML file. For example, the content of the JS file and the CSS file may be inlined into the HTML file described in the foregoing Example 1, to obtain the optimized copy of the HTML file, as shown in the following Example 3:

### Example 3

```
<head>
    <script language=“javascript”>
    alert(“welcome”)
    </script>
    <style type=“text/css”>
    hr{color:sienna;}
    p{margin-left:20px;}
    body{background-image:url(“images/back40.gif”)}
    </style>
</head>
<body>
    <p>welcome</p>
</body>
```

In addition, the content of the JS file and the CSS file may be inlined into the HTML file described in Example 2, to obtain the optimized copy of the HTML file, as shown in the following Example 4:

### Example 4

```
<head>
    <style type=“text/css”>
    hr{color:sienna;}
    p{margin-left:20px;}
    body{background-image:url(“images/back40.gif”);}
    </style>
</head>
<body>
  <script language=“javascript”>
    alert(“welcome”)
    </script>
  <p>welcome</p>
</body>
```

Step 26: The cache device returns the optimized copy to the user equipment.

Step 27: The cache device disconnects the TCP connection to the user equipment.

In this embodiment of the present invention, after the processor 20 of the Web cache device inlines the content of the JS file and the CSS file into the original copy of the HTML file, and generates the optimized copy of the HTML file, the transceiver 10 may send the optimized copy of the HTML file to the user equipment. After receiving the optimized copy, which is described in the foregoing Example 3 or Example 4, of the Web HTML file, the user equipment can directly execute the content of the HTML file to display the Web page without requesting the externally independent JS file and CSS file.

In this embodiment of the present invention, the Web cache device can acquire an external JS file and an external CSS file from a Web cache or a Web server, inline content of the JS file and the CSS file into an original copy of an HTML file, to generate an optimized copy of the HTML file, and then return the optimized copy of the HTML file to user equipment, so that after receiving the optimized copy of the HTML file, the user equipment can directly execute content of the HTML file to display a web page. According to the method for optimizing access to a web page described in this embodiment of the present invention, the number of requests initiated by the user equipment may be decreased, network traffic between the user equipment and the cache device and a web page access latency are reduced, a speed of accessing the web page by the user equipment is increased, and user experience of a user in Web access is improved.

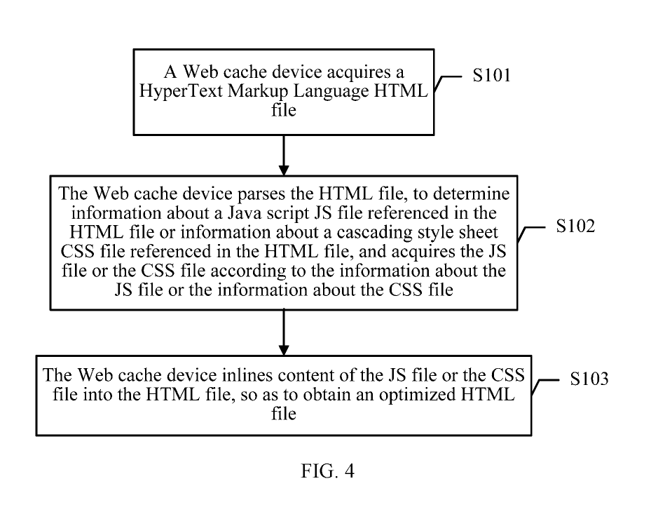

FIG. 4 is a schematic flowchart of an embodiment of a method for optimizing access to a web page according to an embodiment of the present invention. The method for optimizing access to a web page described in this embodiment includes steps:

S101: A Web cache device acquires a HyperText Markup Language HTML file.

S102: The Web cache device parses the HTML file, to determine information about a Java script JS file referenced in the HTML file or information about a cascading style sheet CSS file referenced in the HTML file, and acquires the JS file or the CSS file according to the information about the JS file or the information about the CSS file.

S103: The Web cache device inlines content of the JS file or the CSS file into the HTML file, so as to obtain an optimized HTML file.

In some feasible implementation manners, user equipment may interact with a Web server (or briefly referred to as a server) by using a cache device (which is also referred to as a Web cache device, a Web proxy device, or another network device having functions of a Web cache and a Web proxy). In specific implementation, an implementation manner in which the user equipment interacts with the server by using the Web cache device or the Web proxy device may include two cases: a non-transparent proxy and a transparent proxy. The non-transparent proxy refers to that the user equipment perceives existence of the Web cache device, and when accessing a web page, the user equipment directly sends an HTTP request to the Web cache device; after receiving the HTTP request, the Web cache device serves as a proxy and forwards the HTTP request to the Web server; and after receiving the HTTP request, the Web server sends an HTTP response to the Web cache device according to requested content of the web page, and after receiving the HTTP response, the Web cache device serves as a proxy and forwards the HTTP response to the user equipment. The transparent proxy refers to that the user equipment does not perceive existence of the Web cache device (or the Web proxy device), and when accessing a web page, the user equipment directly sends the HTTP request to the Web server; after the Web cache device that serves as a proxy intercepts the HTTP request, the Web cache device masquerades as the user equipment to forward the HTTP request to the Web server; and after receiving the HTTP request, the Web server directly sends an HTTP response to the user equipment according to requested content of the web page, and after the Web cache device that serves as a proxy intercepts the HTTP response, the Web cache device masquerades as the Web server to forward the HTTP response to the user equipment. For both the non-transparent proxy and the transparent proxy, the user equipment interacts with the Web server by using the cache device. An implementation process of the present invention is specifically described below based on the background of the proxy technology.

In the prior art, in order to alleviate network congestion, and reduce bandwidth and a latency in Web access of a user, an operator mainly optimizes Web access by using a Web caching technology, of which the basic principle is shown in FIG. 2A and FIG. 2B. Referring to FIG. 2A and FIG. 2B, an implementation process of optimizing Web access by using the Web caching technology in the prior art includes:

Step 1: User equipment establishes a TCP connection to a cache device. That is, user equipment may first establish a TCP connection to a cache device, so as to request data from a server by using the cache device.

Step 2: The user equipment requests an HTML file from the cache device. After receiving the request of the user equipment, the cache device acquires the HTML file from a cache or requests the HTML file from the server, and returns the acquired HTML file to the user equipment.

Step 3: The cache device searches a cache for the HTML file, and if the cache device does not find the HTML file, the cache device requests the HTML file from the server, or if the cache device finds the HTML file, step 9 is performed.

Step 4: The cache device establishes a TCP connection to the server. After establishing a TCP connection to the server, the cache device may request the HTML file from the server.

Step 5: The cache device requests the HTML file from the server. After receiving the request of the cache device, the server may return the HTML file to the cache device, so that the HTML file is returned to the user equipment by using the cache device.

Step 6: The server returns the HTML file to the cache device.

Step 7: Disconnect the TCP connection.

Step 8: The cache device stores the HTML file in the cache according to a cache condition, and sends the HTML file to the user equipment. That is, after receiving the HTML file returned by the server, the cache device may store, in the cache according to a cache condition, the HTML file returned by the server, and return the HTML file to the user equipment. After the HTML file is stored in the cache, when the user equipment requests the HTML file next time, the cache device can directly find the HTML file in the cache, and return the HTML file to the user equipment.

Step 9: The cache device returns the HTML file to the user equipment.

Step 10: The user equipment parses the HTML file, and determines that an external JS file needs to be acquired. That is, the user equipment may parse the HTML file returned by the cache device, if it is obtained by parsing that an external JS file is referenced in the HTML file, the user equipment needs to request the external JS file from the cache device or the server, and only after acquiring the JS file referenced in the HTML file, the user equipment can execute the HTML file to display content of a web page.

Step 11: The user equipment requests the JS file from the cache device.

Step 12: The cache device searches the cache for the JS file, and if the cache device does not find the JS file, the cache device requests the JS file from the server, or if the cache device finds the JS file, step 18 is performed, that is, the JS file is returned to the user equipment.

Step 13: The cache device establishes a TCP connection to the server. That is, when requesting the JS file from the server, the cache device may first establish a TCP connection to the server, and then send a request to the server.

Step 14: The cache device requests the JS file from the server.

Step 15: The server returns the JS file to the cache device. That is, after receiving the request for acquiring the JS file by the cache device, the server may return the JS file to the cache device, and after acquiring the JS file, the cache device may send the JS file to the user equipment.

Step 16: The cache device disconnects the TCP connection to the server. After returning the JS file to the cache device, the server may disconnect the TCP connection.

Step 17: The cache device stores the JS file in the cache according to a cache condition, and sends the JS file to the user equipment. That is, after receiving the JS file returned by the server, the cache device may store the acquired JS file in the cache according to a cache condition, and send the JS file to the user equipment. After the JS file is stored in the cache, if the user equipment requests acquiring the JS file next time, the cache device can search the cache for the JS file, and return the JS file to the user equipment without requesting the JS file from the server.

Step 18: The cache device returns the JS file to the user equipment.

Step 19: The user equipment parses the HTML file, and determines that a CSS file needs to be acquired. That is, the user equipment may parse the HTML file returned by the cache device, if it is obtained by parsing that an external CSS file is referenced in the HTML file, the user equipment needs to request the external CSS file from the cache device or the server, and only after acquiring the CSS file referenced in the HTML file, the user equipment can execute the HTML file to display the content of the web page.

Step 20: The user equipment requests the CSS file from the cache device.

Step 21: The cache device searches the cache for the CSS file, and if the cache device does not find the CSS file, the cache device requests the CSS file from the server, or if the cache device finds the CSS file, step 27 is performed, that is, the CSS file is returned to the user equipment.

Step 22: The cache device establishes a TCP connection to the server. That is, when requesting the CSS file from the server, the cache device may first establish a TCP connection to the server, and then send a request to the server.

Step 23: The cache device requests the CSS file from the server.

Step 24: The server returns the CSS file to the cache device. That is, after receiving the request for acquiring the CSS file by the cache device, the server may return the CSS file to the cache device, and after acquiring the CSS file, the cache device may send the CSS file to the user equipment.

Step 25: The cache device disconnects the TCP connection to the server. After returning the CSS file to the cache device, the server may disconnect the TCP connection.

Step 26: The cache device stores the CSS file in the cache according to a cache condition, and sends the CSS file to the user equipment. That is, after receiving the CSS file returned by the server, the cache device may store the acquired CSS file in the cache according to a cache condition, and send the CSS file to the user equipment. After the CSS file is stored in the cache, if the user equipment requests acquiring the CSS file next time, the cache device can search the cache for the CSS file, and return the CSS file to the user equipment without requesting the CSS file from the server.

Step 27: The cache device returns the CSS file to the user equipment.

Step 28: Disconnect the TCP connection.

It can be known from the foregoing content that, in the existing Web caching technology, content of an original web page is returned by a Web cache device to user equipment, and if an external CSS file and/or JS file is referenced in the original web page, the user equipment initiates another request to the Web cache device or a Web server, to request the external CSS file and/or JS file referenced in the original web page. It can be seen that, only network traffic between the Web cache device and the Web server can be reduced by using the existing Web caching technology, network traffic between a client and the Web cache device cannot be reduced, and a latency of Web access cannot be reduced, either. In this embodiment of the present invention, a Web cache device may parse an acquired HTML file, determine a JS file or CSS file referenced in the HTML file, inline content of the acquired JS file and CSS file into the HTML file, to obtain an optimized HTML file, and then send the optimized HTML file to user equipment. The user equipment can directly execute the optimized HTML file without requesting the JS file or the CSS file. The method for optimizing a web page provided in this embodiment of the present invention is specifically described below with reference to FIG. 3A and FIG. 3B.

Referring to FIG. 3A and FIG. 3B, a process in which a Web cache device provided in an embodiment of the present invention optimizes a web page may include:

Step 1: User equipment establishes a TCP connection to a cache device. When the user equipment accesses a web page, a Web cache device (that is, the cache device described in FIG. 3A and FIG. 3B) serves as a proxy, and may first establish a TCP connection to the user equipment. After establishing the TCP connection to the cache device, the user equipment may initiate an HTTP request for acquiring an HTML file to the Web cache device, for example, the user equipment may request an HTML file of a web page “sport.sina.com/football.html” from the Web cache device. After receiving the request that is for acquiring the HTML file and is initiated by the user equipment, the Web cache device may search a Web cache for an original copy or an optimized copy of the HTML file of the web page “sport.sina.com/football.html” according to a user policy. For example, when the user policy indicates that the original copy is to be returned, the cache device may search the Web cache for the original copy of the page “sport.sina.com/football.html”, and if the cache device finds the original copy, the cache device returns the original copy to the user equipment; otherwise, the cache device requests the original copy of the page “sport.sina.com/football.html” from a Web server, and returns the original copy to the user equipment. When the user policy indicates that the optimized copy is to be returned, the cache device may search the Web cache for the optimized copy of the page “sport.sina.com/football.html”, and if the cache device finds the optimized copy, the cache device returns the optimized copy to the user equipment; otherwise, the cache device generates the optimized copy of the page “sport.sina.com/football.html”, and returns the optimized copy to the user equipment. In specific implementation, a specific implementation manner of returning the original copy of the web page to the user equipment is an existing implementation manner (for details, reference may be made to the implementation manner corresponding to FIG. 2A and FIG. 2B in the prior art), and is not specifically described again in this embodiment of the present invention. A specific implementation manner of returning the optimized copy (that is, an optimized HTML file) of the web page to the user equipment is described below.

Step 2: The user equipment requests an HTML file from the cache device.

Step 3: The cache device searches a cache for an original copy or an optimized copy of the HTML file.

In some feasible implementation manners, after receiving the request that is for acquiring the HTML file and is initiated by the user equipment, the Web cache device searches the Web cache for the HTML file, and if the Web cache device finds the HTML file in the Web cache, the Web cache device may directly acquire the HTML file from the Web cache; otherwise, the Web cache device may request the HTML file from the Web server, acquire the HTML file from the Web server, and store the acquired HTML file in the Web cache according to a cache condition.

Step 4: The cache device establishes a TCP connection to a server.

Step 5: The cache device requests the HTML file from the server.

Step 6: The server returns the HTML file to the cache device.

Step 7: The cache device disconnects the TCP connection to the server.

Specifically, when requesting the HTML file from the server, the Web cache device may first establish a TCP connection to the Web server, and after the TCP connection is established, the Web cache device may request the HTML file of the web page “sport.sina.com/football.html” from the Web server. After receiving the request of the Web cache device, the Web server may return the HTML file of the web page “sport.sina.com/football.html” to the Web cache device, and after the HTML file is successfully returned, the Web cache device disconnects the TCP connection.

Step 8: The cache device uses the HTML file as the original copy and stores the original copy in the cache according to a cache condition.

In some feasible implementation manners, after acquiring the HTML file returned by the Web server, the Web cache device may store the HTML file in the Web cache according to the cache condition. Specifically, after acquiring the HTML file of the web page “sport.sina.com/football.html” from the server, the Web cache device may use the acquired HTML file as the original copy of the web page and store the HTML file in the Web cache, and then may inline content of a JS file and/or content of a CSS file referenced in the web page into the original copy (description is made below by using an example in which the content of the JS file and the CSS file is inlined into the original copy), to generate the optimized copy (that is, the optimized HTML file) of the HTML file.

Step 9: The cache device returns the original copy of the HTML file to the user equipment.

Step 10: The cache device disconnects the TCP connection to the user equipment.

Step 11: The cache device parses the HTML file, and determines a JS file referenced in a current page.

Step 12: The cache device searches the cache for the JS file, and if the cache device does not find the JS file, the cache device requests the JS file from the server, or if the cache device finds the JS file, step 18 is performed.

Step 13: The cache device establishes a TCP connection to the server.

Step 14: The cache device requests the JS file from the server.

Step 15: The server returns the JS file to the cache device.

Step 16: The cache device disconnects the TCP connection to the server.

Step 17: The cache device stores the JS file in the cache according to a cache condition.

Step 18: The cache device parses the HTML file, and determines a CSS file referenced in the current page.

Step 19: The cache device searches the cache for the CSS file, and if the cache device does not find the CSS file, the cache device requests the CSS file from the server, or if the cache device finds the CSS file, step 25 is performed.

Step 20: The cache device establishes a TCP connection to the server.

Step 21: The cache device requests the CSS file from the server.

Step 22: The server returns the CSS file to the cache device.

Step 23: The cache device disconnects the TCP connection to the server.

Step 24: The cache device stores the CSS file in the cache according to a cache condition.

In some feasible implementation manners, after acquiring the HTML file of the web page “sport.sina.com/football.html” from the Web cache or the Web server, the Web cache device may parse the HTML file, and determine a JS file and a CSS file that are referenced in the web page (that is, the page “sport.sina.com/football.html” corresponding to the HTML file) to which access is requested by the user equipment. After determining the JS file and the CSS file that are referenced in the page, the Web cache device may search the Web cache for the JS file and the CSS file. Specifically, after parsing the HTML file of the web page “sport.sina.com/football.html”, and determining that the JS file referenced in the page is “sport.sina.com/football.js”, the Web cache device may search the Web cache for “sport.sina.com/football.js”. If the Web cache device finds the JS file in the Web cache, the Web cache device may acquire the JS file from the Web cache, and if the Web cache device does not find the JS file in the Web cache, the Web cache device may request the JS file from the Web server. Specifically, when requesting the JS file from the Web server, the Web cache device may first establish a TCP connection to the Web server, and may send a request for acquiring the JS file to the Web server after the TCP connection is established. After receiving the request for the Web cache device, the Web server may return the JS file to the Web cache device, and then the TCP connection may be disconnected. After receiving the JS file returned by the Web server, the Web cache device may store the JS file in the Web cache according to a cache condition. Similarly, after parsing the HTML file of the web page “sport.sina.com/football.html”, and determining that the CSS file referenced in the page is “sport.sina.com/football.css”, the Web cache device may search the Web cache for “sport.sina.com/football.css”. If the Web cache device finds the CSS file in the Web cache, the Web cache device may acquire the CSS file from the Web cache, and if the Web cache device does not find the CSS file in the Web cache, the Web cache device may request the CSS file from the Web server. Specifically, when requesting the CSS file from the Web server, the Web cache device may first establish a TCP connection to the Web server, and may send a request for acquiring the CSS file to the Web server after the TCP connection is established. After receiving the request for the Web cache device, the Web server may return the CSS file to the Web cache device, and then the TCP connection may be disconnected. After receiving the CSS file returned by the Web server, the Web cache device may store the CSS file in the Web cache according to a cache condition. After acquiring the JS file and the CSS file, the Web cache device may inline the content of the JS file and the content of the CSS file into the original copy of the HTML file, so as to generate the optimized copy.

Step 25: The cache device inserts content of the JS file and the CSS file into the HTML file by means of inlining, to obtain the optimized copy of the HTML file, and stores the optimized copy in the cache.

In some feasible implementation manners, after acquiring the JS file and the CSS file, the Web cache device may inline the content of the JS file and the content of the CSS file into the original copy of the HTML file, to generate the optimized copy of the HTML file. In this embodiment of the present invention, the optimized copy of the HTML file is used for directly executing the HTML file and displaying the web page by the user equipment. In this embodiment of the present invention, the content of the JS file is used for indicating an element, such as an event, a variable, a trigger, or a function, corresponding to the HTML file, that is, the content of the JS file is used for defining an element, such as an event, a variable, a trigger, or a function, required when the HTML file of the page is interpreted and executed by a browser of the user equipment. The content of the CSS file is used for indicating a display style corresponding to the HTML file, that is, the content of the CSS file is used for defining a display style of the HTML file of the page. In an existing implementation manner, when an original copy of an HTML file references an external JS file, a URL of the JS file may be first specified in a <script> tag of the original copy, and the external JS file is referenced by using the specified URL of the JS file, that is, the JS file is referenced in the HTML file by using the URL in the <script> tag. Specifically, the <script> tag may be placed between a tag pair <head></head> of the HTML file (that is, the original copy), which is shown in Example 1 described in the foregoing embodiment:

### Example 1

```
<head>
    <script language=“javascript”
Src=“http://sports.sina.com/football.js”>
    </script>
    <link rel=“stylesheet” type=“text/css” href=
“http:/sprots.sina.com/football.css”/>
</head>
<body>
    <p>welcome</p>
</body>
```

In addition, the <script> tag may also be placed between a tag pair <body></body> of the HTML file, which is shown in Example 2 described in the foregoing embodiment:

### Example 2

```
<head>
    <style type=“text/css”>
    @import url(http:/sprots.sina.com/football.css);
    </style>
</head>
<body>
  <script language=“javascript”
src=“http://sports.sina.com/football.js”>
    </script>
<p>welcome</p>
</body>
```

In specific implementation, when the original copy of the HTML file references an external CSS file, a URL of the CSS file may be first specified in a <link> tag of the original copy, and the external CSS file is referenced by using the URL of the CSS file, as shown in the foregoing Example 1. In addition, when the original copy of the HTML file references the external CSS file, the URL of the CSS file may also be specified in an @import tag of the original copy, and the external CSS file is referenced by using the @import URL, as shown in the foregoing Example 2. After the user equipment receives the original copy, which includes the content described in the foregoing Example 1 or Example 2, of the HTML file, if the user equipment does not cache the CSS file (sport.sina.com/football.css) and the JS file (sport.sina.com/football.js), the user equipment further initiates other two web requests, to separately request the content of the JS file (sport.sina.com/football.js) and the content of the CSS file (sport.sina.com/football.css), so as to acquire the JS file and the CSS file, which increases communication traffic between the user equipment, the Web cache device, and the server as well as a latency of Web access. In this embodiment of the present invention, the content of the JS file and the CSS file may be inlined into the original copy of the HTML file, so as to reduce the number of requests initiated by the user equipment, reduce the communication traffic between the user equipment, the Web cache device, and the server, and increase a speed of accessing the web page.

In specific implementation, the Web cache device may insert the content of the JS file into the HTML file, so that the HTML file includes a tag pair <script language=“javascript”></script>, where the tag pair <script language=“javascript”></script> includes the content of the JS file. The Web cache device may insert the content of the CSS file into the HTML file, so that the HTML file includes a tag pair <style type=“text/css”></style>, where the tag pair <style type=“text/css”></style> includes the content of the CSS file. Specifically, the Web cache device may first place the content of the acquired JS file between the tag pair <script language=“javascript”></script> shown in Example 1, and place the content of the CSS file between the tag pair <style type=“text/css”></style>. When inlining the content of the JS file into the original copy of the HTML file, the Web cache device may replace a tag pair <script></script>, which references the external JS file by using the URL, in the original copy of the HTML with the tag pair <script language=“javascript”></script> including the content of the JS file, that is, the Web cache device may delete a reference to the JS file from the HTML file, and directly insert the content of the JS file into the HTML file. When inlining the content of the CSS file into the original copy of the HTML file, the Web cache device may replace a tag pair <style></style>, which references the external JS file by using the <link> tag, in the original copy of the HTML with the tag pair <style type=“text/css”></style> including the content of the CSS file, that is, the Web cache device may delete a reference to the CSS file from the HTML file, and directly insert the content of the CSS file into the HTML file. When inlining the content of the CSS file into the original copy of the HTML file, the Web cache device may also replace a tag pair <style></style>, which references the external CSS file by using an @import URL, in the original copy of the HTML with the tag pair <style type=“text/css”></style> including the content of the CSS file. In specific implementation, the Web cache device may acquire the JS file and the CSS file from the Web cache or the Web server. For example, the content of the JS file is:

“alert(‘welcome’)”;

for example, the content of the CSS file is:

“hr {color: sienna;}

p {margin-left: 20px;}

body {background-image: url(“images/back40.gif”}”

After acquiring the content of the JS file and the CSS file, the Web cache device may inline the content of the JS file and the CSS file into the original copy of the HTML file. For example, the content of the JS file and the CSS file may be inlined into the HTML file described in the foregoing Example 1, to obtain the optimized copy of the HTML file, as shown in Example 3 described in the foregoing embodiment:

### Example 3

```
<head>
    <script language=“javascript”>
    alert(“welcome”)
    </script>
    <style type=“text/css”>
    hr{color:sienna;}
    p{margin-left:20px;}
    body{background-image:url(“images/back40.gif”)}
    </style>
</head>
<body>
    <p>welcome</p>
</body>
```

In addition, the content of the JS file and the CSS file may be inlined into the HTML file described in the foregoing Example 2, to obtain the optimized copy of the HTML file, as shown in Example 4 described in the foregoing embodiment:

### Example 4

```
<head>
    <style type=“text/css”>
    hr{color:sienna;}
    p{margin-left:20px;}
    body{background-image:url(“images/back40.gif”);}
    </style>
</head>
<body>
  <script language=“javascript”>
    alert(“welcome”)
    </script>
<p>welcome</p>
</body>
```

Step 26: The cache device returns the optimized copy to the user equipment.

Step 27: The cache device disconnects the TCP connection to the user equipment.

In this embodiment of the present invention, after inlining the content of the JS file and the CSS file into the original copy of the HTML file, and generates the optimized copy of the HTML file, the Web cache device may send the optimized copy of the HTML file to the user equipment. After receiving the optimized copy, which is described in the foregoing Example 3 or Example 4, of the Web HTML file, the user equipment can directly execute the content of the HTML file to display the Web page without requesting the externally independent JS file and CSS file.

In this embodiment of the present invention, a Web cache device can acquire an external JS file and an external CSS file from a Web cache or a Web server, inline content of the JS file and the CSS file into an original copy of an HTML file, to generate an optimized copy of the HTML file, and then return the optimized copy of the HTML file to user equipment, so that after receiving the optimized copy of the HTML file, the user equipment can directly execute content of the HTML file to display a web page. According to the method for optimizing access to a web page described in this embodiment of the present invention, the number of requests initiated by the user equipment may be decreased, network traffic between the user equipment and the cache device and a web page access latency are reduced, a speed of accessing the web page by the user equipment is increased, and user experience of a user in Web access is improved.

A person of ordinary skill in the art should understand that all or a part of the processes of the method in the foregoing embodiment may be implemented by a program instructing relevant hardware. The program may be stored in a computer readable storage medium. When the program is run, the processes of the method in the foregoing embodiment are performed. The storage medium may be a magnetic disk, an optical disc, a read-only memory (Read-Only Memory, ROM) or a random access memory (Random Access Memory, RAM), or the like.

What is disclosed above is merely exemplary embodiments of the present invention, and certainly is not intended to limit the protection scope of the present invention. Therefore, equivalent variations made in accordance with the claims of the present invention shall fall within the scope of the present invention.

1. A Web cache device, comprising:
a transceiver, configured to acquire a HyperText Markup Language (HTML) file;
at least one processor;
a non-transitory computer-readable storage medium coupled to the at least one hardware processor and storing programming instructions for execution by the at least one hardware processor, wherein the programming instructions instruct the at least one hardware processor to:
parse the HTML file acquired by the transceiver;
determine information about a Java script (JS) file referenced in the HTML file or information about a cascading style sheet (CSS) file referenced in the HTML file; and
wherein
the transceiver is further configured to acquire the JS file or the CSS file according to the information about the JS file or the information about the CSS file; and
the programming instructions instruct the at least one hardware processor to inline content of the JS file or the CSS file acquired by the transceiver into the HTML file to obtain an optimized HTML file.

2. The device according to claim 1, wherein the programming instructions instruct the at least one hardware processor to:
insert the content of the JS file into the HTML file to include a tag pair <script language=“javascript”></script>, wherein the tag pair <script language=“javascript”></script> comprises the content of the JS file; and
delete a reference to the JS file from the HTML file.

3. The device according to claim 1, wherein the programming instructions instruct the at least one hardware processor to:
insert the content of the CSS file into the HTML file to include a tag pair <style type=“text/css”></style>, wherein the tag pair <style type=“text/css”></style> comprises the content of the CSS file; and
delete a reference to the CSS file from the HTML file.

4. The device according to claim 1, wherein the content of the JS file is used for indicating at least one of the following elements that correspond to the HTML file: an event, a variable, a trigger, and a function.

5. The device according to claim 1, wherein the content of the CSS file is used for indicating a display style corresponding to the HTML file.

6. The device according to claim 1, wherein the JS file is referenced in the HTML file by using a uniform resource locator (URL) in a <script> tag.

7. The device according to claim 1, wherein the CSS file is referenced in the HTML file by using a URL in a <link> tag or by using an @import URL.

8. The device according to claim 1, wherein the device further comprises a storage, configured to cache the optimized HTML file.

9. The device according to claim 8, wherein the transceiver is configured to:
receive a request message of user equipment, wherein the request message is used for requesting the HTML file; and
send the optimized HTML file to the user equipment.

10. A method for optimizing a web page, comprising:
acquiring, by a Web cache device, a HyperText Markup Language (HTML) file;
parsing, by the Web cache device, the HTML file, to determine information about a Java script JS file referenced in the HTML file or information about a cascading style sheet CSS file referenced in the HTML file;
acquiring the JS file or the CSS file according to the information about the JS file or the information about the CSS file; and
inlining, by the Web cache device, content of the JS file or the CSS file into the HTML file to obtain an optimized HTML file.

11. The method according to claim 10, wherein the inlining, by the Web cache device, content of the JS file into the HTML file comprises:
inserting, by the Web cache device, the content of the JS file into the HTML file to include a tag pair <script language=“javascript”></script>, wherein the tag pair <script language=“javascript”></script> comprises the content of the JS file; and
deleting, by the Web cache device, a reference to the JS file from the HTML file.

12. The method according to claim 10, wherein the inlining, by the Web cache device, content of the CSS file into the HTML file comprises:
inserting, by the Web cache device, the content of the CSS file into the HTML file to include a tag pair <style type=“text/css”></style>, wherein the tag pair <style type=“text/css”></style> comprises the content of the CSS file; and
deleting, by the Web cache device, a reference to the CSS file from the HTML file.

13. The method according to any one of claim 10, wherein the content of the JS file is used for indicating at least one of the following elements that corresponds to the HTML file:
an event, a variable, a trigger, and a function.

14. The method according to claim 10, wherein the content of the CSS file is used for indicating a display style corresponding to the HTML file.

15. The method according to claim 10, wherein the JS file is referenced in the HTML file by using a uniform resource locator (URL) in a <script> tag.

16. The method according to of claim 10, wherein the CSS file is referenced in the HTML file by using a URL in a <link> tag or by using an @import URL.

17. The method according to claim 10, wherein the Web cache device caches the optimized HTML file.

18. The method according to claim 17, wherein the method further comprises:
receiving, by the Web cache device, a request message of user equipment, wherein the request message is used for requesting the HTML file; and
sending, by the Web cache device, the optimized HTML file to the user equipment.
